(19) United States
(12) Patent Application Publication
(10) Pub. No.: US 2007/0127244 A1
(43) Pub. Date: Jun. 7, 2007

(54) Fluorescent lighting fixture with extruded housing

(75) Inventor: Jeff R. Cunius, Ontario, CA (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(73) Assignee: Troy-CSL Lighting, Inc.

(21) Appl. No.: 11/295,393

(22) Filed: Dec. 5, 2005

(51) Int. Cl. F21V 23/02

(52) U.S. Cl. 362/260

(57) ABSTRACT

A fluorescent light fixture has an extrusion with opposite extrusion ends, a lens hinged to a front side of the extrusion to provide a lamp compartment containing a lamp tube between lamp sockets mounted to the extrusion ends, a rear cover retained to the rear side of the extrusion to provide a wiring compartment containing a lamp ballast, and end caps on the extrusion ends for closing opposite ends of the wiring compartment and lamp enclosure. The extrusion is generally T-shaped with a horizontal top and a vertical partition, the lens on one side of the partition and the cover on the opposite side of the partition. The lens is hinged to the extrusion by a hinge formed integrally with the lens and the extrusion.

### BACKGROUND OF THE INVENTION

1. Field of the Invention

This invention relates to electric lighting fixtures and more particularly concerns a fluorescent counter lighting fixture of the type suitable for mounting to the underside of wall mounted cabinets for illuminating an underlying counter surface, such as in kitchens and the like.

2. State of the Prior Art

Under cabinet lighting fixtures are in common use and are available from many suppliers in a variety of designs, sizes and configurations, with both fluorescent and incandescent light sources. Nonetheless, improvement is desirable in ease of assembly, installation and maintenance, economy of manufacture and other aspects of such light fixtures.

### SUMMARY OF THE INVENTION

This invention provides a light fixture having a housing body in the form of an extrusion with opposite extrusion ends, an extrusion front and an extrusion rear; a top and a bottom, parallel front edges along the extrusion front between the opposite extrusion ends, parallel rear edges along the extrusion rear between the opposite extrusion ends, a lens configured to make retentive engagement with the front edges for defining a lamp enclosure with the extrusion, a rear cover configured to make retentive engagement with the rear edges for defining a substantially closed wiring compartment between the ends, opposite lamp tube sockets for supporting a lamp tube in front of and alongside the front end.

In the presently preferred form of the invention the lamp tube is a fluorescent lamp of the type requiring a ballast. The ballast is contained and mounted in the wiring compartment, preferably fastened as by a screw to the rear of the extrusion. The ballast is connected to the lamp tube sockets for powering the lamp tube. A pair of end caps are provided for closing the wiring compartment and the lamp enclosure at the extrusion ends. A switch may be mounted on the rear cover and electrically connected for controlling power to the lamp tube sockets.

The extrusion front may be shaped to provide a curved light reflector surface shaped for reflecting light emited by the lamp tube away from the extrusion. The curved light reflector surface may be generally parabolic in cross section, and may include reflector grooves of curved, e.g. parabolic, cross section, such as a number of mutually parallel grooves extending from one to the other of the opposite extrusion ends

The lamp sockets may be supported in socket holders fastened to the extrusion ends and contained in the end caps. For example, the sockets can be configured to make a retentive snap fit in the socket holders, and the socket holders may be fastened to the extrusion ends by screws threaded into extruded screw bosses integral to the extrusion. The end caps too may be retained to the socket holders by a snap fit.

One of the front edges and the lens are preferably configured to make hinging engagement with each other thereby enabling pivotal rotation of the lens between a closed condition for covering the lamp tube and an open condition for access to the lamp tube. For example, one front edge may define in transverse cross section a circularly curved slot open along the extrusion front and the lens may have an edge portion of circularly curved cross section adapted to make a sliding fit in the curved slot thereby to achieve hinging engagement between the lens and the extrusion. In the preferred form of the invention the extrusion includes an extruded first hinge-half and the lens has a second hinge-half, the two hinge halves being configured to assemble as by sliding one into the other for hinging movement of the lens relative to the extrusion. Preferably the hinge halves are integral to the extrusion and the lens, respectively. It is preferred to hinge the lens to a lower one of the front edges such that the lens can be hinged to an open condition dependent from the lower front edge for access to the lamp tube. The lens preferably makes a retentive snap fit with the other front edge to keep the lens normally closed over the lamp tube.

The rear cover preferably makes a snap fit with the rear edges of the extrusion, such that both the lens and the rear cover can be assembled to and removed from the extrusion manually without use of tools or separate fasteners. The extrusion and the rear cover are preferably both extrusions of metal, such as aluminum extrusions, and the lens, end caps and socket holders are molded of plastic.

Electrical end connectors may be provided on each of the end caps, including a male end connector on one cap and a female end connector on the other cap, with removable safety caps on the end connectors.

The housing body extrusion is normally of substantially continuous cross section between its opposite ends, and the extrusion top defines a substantially planar top surface between the extrusion front and extrusion rear. Means are provided for fastening the top surface to an overlying mounting surface such as the underside of a wall cabinet. For example, keyhole openings can be provided in the top surface for receiving a fastener head such as a screw head protruding from an overlying mounting surface.

The invention may be also understood as having a housing extrusion of generally T-shaped cross section including an extrusion top and a generally vertical partition dependent from the top, a lens supported between one side of the planar top and a bottom of the vertical partition for defining a lamp enclosure; and a cover supported between an opposite side of the planar top and the bottom of said vertical partition for defining a wiring compartment. End caps may be provided at opposite ends of the extrusion for closing opposite ends of the lamp compartment and the wiring compartment. One side of the vertical partition may define a light reflector integral with the extrusion. Fastener portions, such as keyhole openings, may be provided in the top surface for receiving mounting fasteners, such as screw heads, so the extrusion can be fastened to an overlying supporting surface, such as the underside of a wall mounted cabinet.

A ballast in the wiring compartment may be connected for powering the lamp, and electrical end connectors provided on the end caps may be connected for supplying electrical power to the ballast, which in turn is connected to lamp sockets supported at opposite ends of the extrusion. One of the end connectors can be connected for receiving electrical power through an external power cord, and the other end connector can supply power to another adjacent lighting fixture by way of another external power cord, so that two or more such lighting fixtures may be connected end-to-end. The end connectors are interconnected to each other and to the ballast by wiring contained in the wiring compartment.

The invention may be also summarized as a lighting fixture comprising a housing body defining a partition, lamp sockets for supporting a lamp on one side of the partition, a lens hinged to the housing body for covering the lamp, a rear cover engageable to the housing body on another side of the partition, a ballast secured to the other side of the partition and electrically connected to the lamp sockets, and end caps on opposite ends of the housing body for covering the lamp sockets. Preferably the housing body is a metal extrusion and the lens is hinged by hinge portions integral to the lens and the housing body. In a preferred form of the invention, the lens, rear cover and end caps are each manually engageable to and removable from housing body without use of tools or separate fasteners. Also, the housing body may have integrally formed screw receiving portions such as extruded screw bosses and the lamp sockets are secured by screw fasteners in the screw receiving portions.

These and other improvements, features and advantages of the present invention will be better understood by reference to the following detailed description of the preferred embodiment taken in conjunction with the accompanying drawings.

### BRIEF DESCRIPTION OF THE DRAWINGS

FIG. 1 is a top, front side perspective view of a fluorescent lighting fixture according to this invention;

FIG. 2 is a cross sectional view taken along line 2-2 in FIG. 1;

FIG. 3 shows the housing body extrusion of the Fixture of FIG.1 with the lens and rear cover installed to define the lamp compartment and wiring compartment respectively on opposite front and rear sides of the extrusion, and with the lamp sockets, socket holders and end caps shown in exploded relationship to the extrusion;

FIG. 4 is a perspective view of one end of the Fixture of FIG.1 partially in phantom lining and with an end cap separated from the extrusion to expose the electrical wiring at that end of the fixture;

FIG. 5 is a wiring diagram of the light fixture of FIG. 1;

FIG. 6 is a perspective view showing the power switch installed on the underside of the rear cover near one end of the light fixture of FIG. 1;

FIG. 7 illustrates direct end-to-end coupling of two adjacent light fixtures; and

FIG. 8 shows end-to-end power connection between two light fixtures by means of an external interlink cable.

### DETAILED DESCRIPTION OF THE PREFERRED EMBODIMENTS

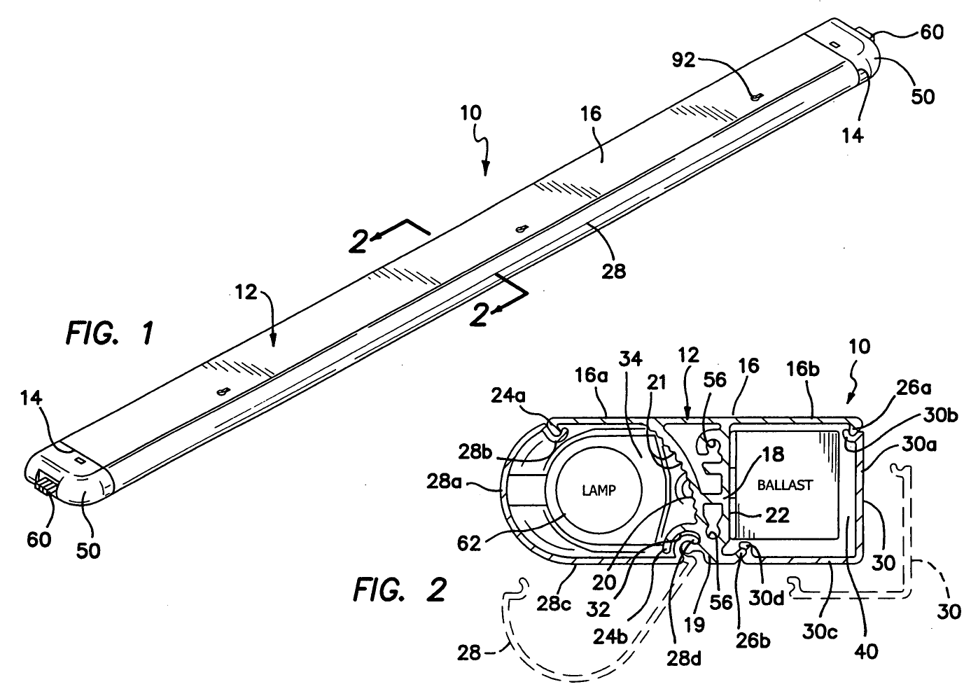

With reference to the accompanying drawings wherein like elements are designated by like numerals, FIG. 1 illustrates a fluorescent lighting fixture generally designated by the numeral 10. Fixture 10 has a housing body in the form of an extrusion 12 with opposite extrusion ends 14. As best seen in FIG. 2, the extrusion 12 is of generally T-shaped cross section with a generally planar top 16, a generally vertical partition 18 dependent from the extrusion top 16, an extrusion bottom 19, an extrusion front 20 and an extrusion rear 22. The partition 18 extends from a generally central portion of the top 16 so that front and rear portions 16a, 16b respectively of the top 16 extend over the front and the back of the extrusion and terminate in front and rear edges 24a, 26a. As seen in FIGS. 1 and 2 the extrusion top 16 is generally planar or flat between the edges 24a, 26a.

The extrusion front has two parallel front edges 24a, 24b and the extrusion rear also has two parallel rear edges 26a, 26b. The fixture 10 also has a lens 28 of translucent material such as plastic and a rear cover 30 which may be also an extrusion.

The currently preferred lens 28 is a sheet of translucent plastic with a curved front 28a, an upper edge 28b, a planar bottom 28c and a lower edge 28d. The lower edge 28d has a semi-circular curvature and makes a sliding fit into a similarly curved extruded slot 32 in the lower front edge 24b of extrusion 12. The lower edge 28d constitutes a first half hinge integral to the lens 28 while the extruded slot 32 is a second half hinge integral to extrusion 12. The extruded slot 32 is defined between a quarter circular curved lip 32a concentric with a center boss 32b. When the two hinge halves are assembled in sliding relationship as shown in FIG. 2 the lens 18 is hinged to the extrusion 12 and can pivot between a closed condition shown in solid lining and an open condition shown in phantom lining in the same Figure. In its closed condition the lens defines a lamp compartment 34 with the front 20 of the extrusion, and in its open condition permits access into this lamp compartment 34. The upper edge 28b of the lens is shaped to make a retentive snap fit over the extrusion front edge 24a as seen in solid lining in FIG. 2, for keeping the lens in its closed condition. The lens is released for opening by manually pressing down on the curved front 28a of the lens to free upper edge 28b from front edge 24a, after which the lens is free to swing down below the extrusion and hang from lower front edge 28d in its open condition, as suggested in phantom lining in FIG. 2. The extrusion front 20 is curved so as to provide a light reflector shaped to direct light from lamp tube 62 generally forwardly and downwardly from the fixture 10. Parallel reflector grooves 21 extending between opposite ends 14 may be formed in extrusion front 20, each groove having a curved cross section such as a parabolic curvature, for better focusing and directing the reflected light.

The rear cover 30 has a cover rear 30a with a first cover edge 30b and a cover bottom 30c with a second cover edge 30d. The cover edges 30b, 30d make a retentive snap fit with the rear edges 26a, 26b of the extrusion 12 so as to hold the cover 30 in a closed condition on extrusion 12 and thereby define a wiring compartment 40 on the rear side 22 of the extrusion. The rear cover 30 can be disengaged and removed from extrusion 12 by manual force without use of tools, as by grasping the extrusion top 16 and the cover bottom 30c, squeezing the cover bottom to press cover edge 30d away from engagement with extrusion edge 26b, and pulling the cover bottom 30c away from extrusion bottom 18, thereby to gain access into the wiring compartment 40.

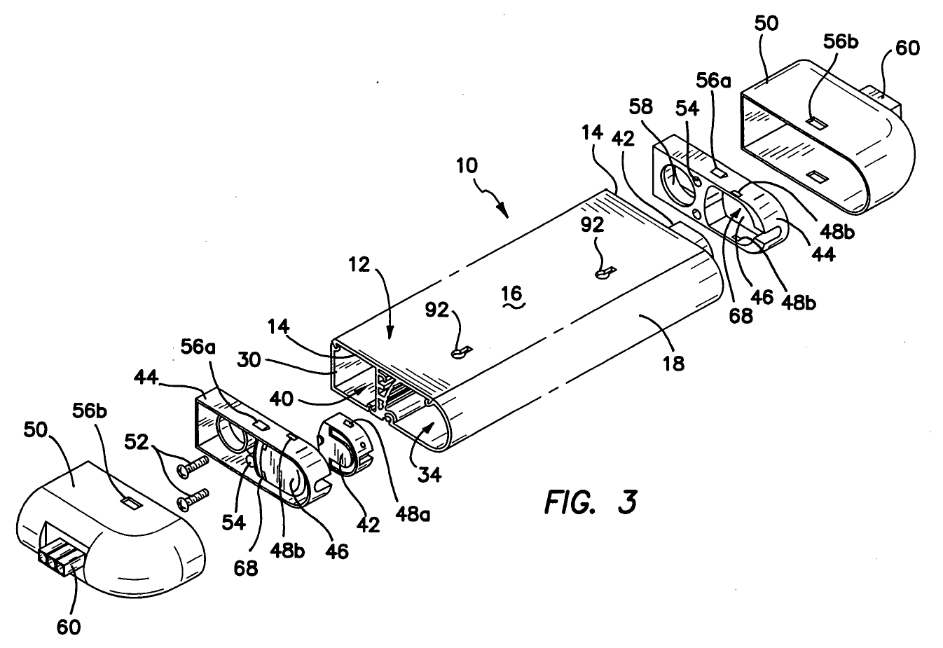

Turning now to FIG. 3, a pair of lamp sockets 42 are supported at opposite ends 14 of extrusion 12 by socket holders 44. Each lamp socket 42 snaps into a receptacle 46 in a corresponding holder 44 and is retained therein by detent tabs 48a which snap into detent openings 48b. Each socket holder 44 is secured to a corresponding extrusion end 14 by screws 52 inserted through screw holes 54 and threaded into extruded screw bosses 56 on the extrusion 12. The socket holders 44 are configured to fit against the ends 14 of the extrusion 12, so as to cover and close the opposite ends of the lamp compartment 34, while supporting sockets 42 in mutually facing relationship for holding and powering a fluorescent lamp tube 62 shown in FIG. 2. Each socket holder 44 has a wiring pass-through opening 58 which admits electrical wiring into wiring compartment 40 and between the end caps 50 for connection to end connectors 60. The socket holders 44 physically close off the lamp compartment 34 from the interior of end caps 50 and from the wiring compartment 40, and prevent contact with wiring by those accessing the lamp compartment 34, e.g., as when installing or changing lamp 62.

A pair of end caps 50 attach to the extrusion ends 14 over the socket holders 44. End caps 50 are held in place by detent tabs 56a on holders 44 which make snap engagement in detent openings 56b in end caps 50. The end caps 50 are somewhat resiliently deformable such that the caps can be manually squeezed front-to-back to slightly lift the tops and bottom of the caps out of engagement with detent tabs 56a, thereby releasing the caps 50 for separation from holders 44 and extrusion 12.

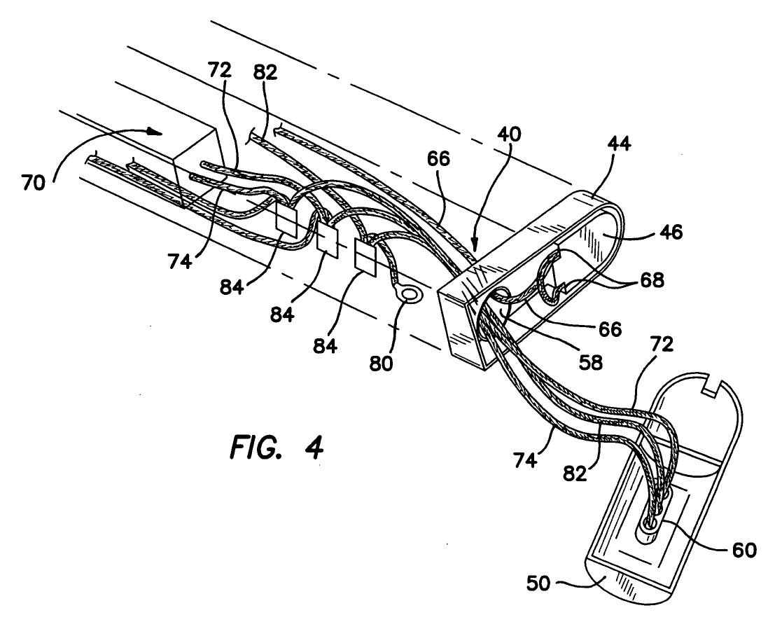

Each end cap 50 carries a 3-prong end connector 60 which is male on one end cap 50 and female on the opposite end cap 50. FIG. 7 shows an electrical wiring diagram of light fixture 10. A ballast 70 is fixed to the extrusion rear 22 within the wiring compartment 40 as shown in FIGS. 2 and 4. Lamp sockets 42 are connected to the output of ballast 70 by socket wires 66 passing through openings 68 in holder receptacles 46, as shown in FIG. 4. The ballast 70 is supplied by hot wire 72 and common or neutral wire 74.

End connectors 60 are also connected by hot and neutral wires 72, 74 in parallel with ballast 70 and are further connected to a ground 80 by ground wires 82. The parallel connection is facilitated by 3-way push-in type connectors 84. The wiring 66, 72, 74, 82 between the opposite end connectors 60 and between the lamp sockets 42 and ballast 70 passes through and is contained in the wiring compartment 40 of light fixture 10, as best seen in FIG. 4.

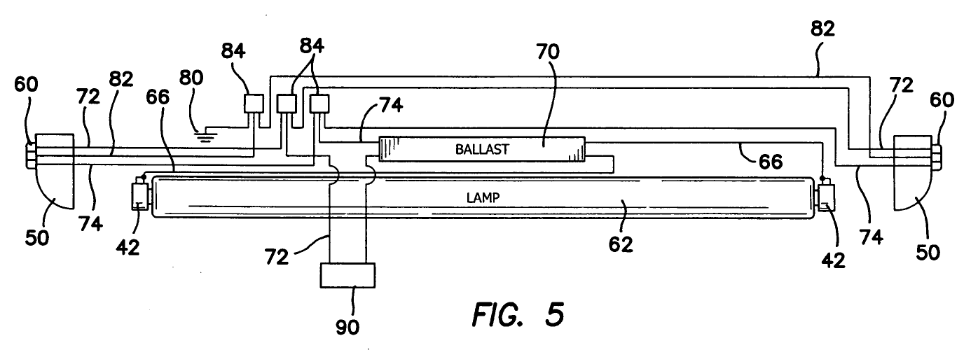

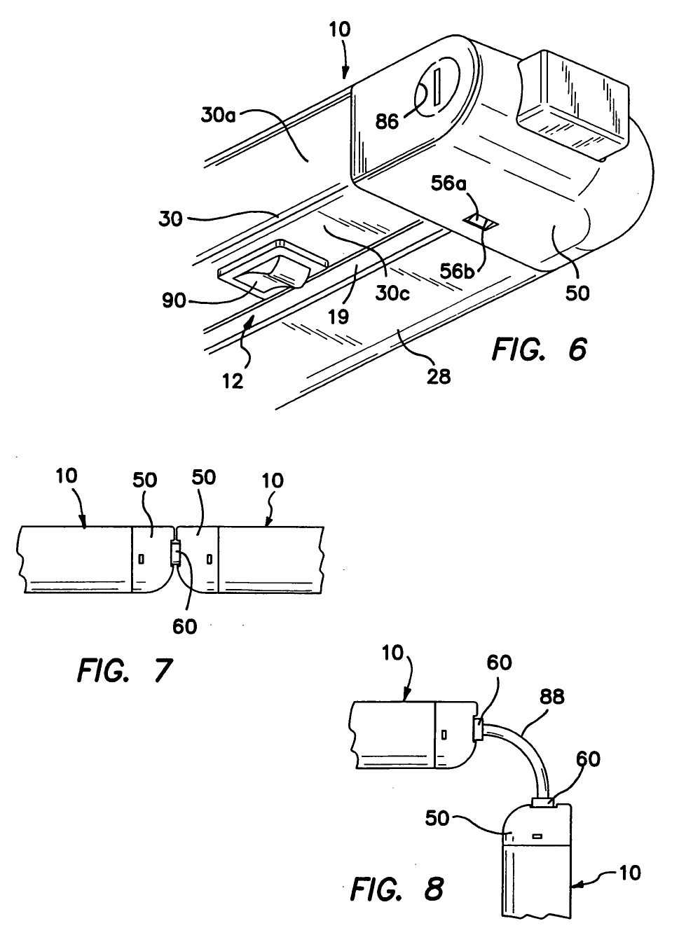

Because of this 3-way connection, electrical power can be supplied to the ballast 70 by appropriate external power cables coupled to either end connector 60. Also, power supplied to one end connector 60 is available at the other end connector 60 of the fixture 10. This feature enables end-to-end coupling or interconnection of two or more adjacent lighting fixtures 10. End-to-end coupling can be accomplished either by way of an interconnect cable 88 as in FIG. 6 or by direct coupling of male and female end connectors 60 as in FIG. 5.

The fixture 10 can be provided with one or more conduit knockouts 86 in each end cap 50. Punching out a knockout 86 opens a hole for admitting electrical conduit with hot/neutral/ground wires which can be connected within end cap 50 or in wiring compartment 40 to corresponding ones of the 3-way connectors 84, thereby to supply power to the fixture 10. When so supplied, a fixture 10 can in turn provide electrical power to two other fixtures 10 each coupled to one end connector 60 of the first fixture 10.

A power switch 90 is mounted on the undersurface 30c of the rear cover 30 as shown in FIG. 4 such that the rear cover 30c can be disengaged and separated from extrusion 12 together with the switch 90 for access to the interior of wiring compartment 40 and to the ballast 70. Switch 90 is connected to interrupt power to ballast 70, for example, by inserting switch 90 in wire 72 between connector 84 and ballast 70, as seen in FIG. 5. In this configuration switch 90 interrupts power to the ballast 70 but does not interrupt the electrical connection between end connectors 60, such that power flow is not affected among multiple light fixtures 10 connected end-to-end by means of the end connectors 60 and individual fixtures 10 can be turned on and off by corresponding switches 90 without affecting power to adjacent connected fixtures 10.

It will be appreciated from the foregoing that the rear cover 30c, the end caps 50 and the lens 18 can all be assembled to and detached from the extrusion 12 manually without use of fasteners or tools. In the presently preferred form of the invention the extrusion 12 and rear cover 30c are both aluminum extrusions, which provide good heat carrying and dissipation characteristics to the fixture 10.

Typical use and installation of fixture 10 is, for example, in kitchens where fixture 10 is mounted to the underside of a wall mounted kitchen cabinet for illuminating an underlying kitchen counter surface. The fixture 10 is provided with two or more keyhole shaped openings 92 cut in the extrusion top 16 as in FIGS. 1 and 3 for receiving screw heads of screws driven into the underside of the overlying mounting surface, i.e., the underside of the wall cabinet, for example.

While a preferred embodiment of the invention has been described and illustrated for purposes of clarity and example, it will be understood that many changes, modifications and substitutions will be apparent to those having only ordinary skill in the art without thereby departing from the scope of this invention as defined by the following claims.

What is claimed is:

1. A fluorescent light fixture comprising:
an extrusion having opposite extrusion ends, an extrusion front and an extrusion rear;
parallel front edges along said front between said opposite extrusion ends;
parallel rear edges along said rear between said opposite extrusion ends;
a lens configured to make retentive engagement with said front edges for defining a lamp enclosure with said extrusion;
a rear cover configured to make retentive engagement with said rear edges for defining a substantially closed wiring compartment between said ends;
opposite lamp tube sockets for supporting a lamp tube along said front end;
a ballast in said wiring compartment connected to said lamp tube sockets; and
end caps for closing said wiring compartment and said lamp enclosure at said opposite extrusion ends.

2. The fluorescent light fixture of claim 1 further comprising a switch mounted on said rear cover and electrically connected for controlling power to said lamp tube sockets.

3. The fluorescent light fixture of claim 1 wherein said extrusion front is shaped to provide a curved light reflector surface.

4. The fluorescent light fixture of claim 1 wherein said curved light reflector surface has a focal area and said sockets are positioned for holding a lamp tube in said focal area.

5. The fluorescent light fixture of claim 1 wherein said curved light reflector surface is generally parabolic in cross section.

6. The fluorescent light fixture of claim 1 wherein said curved light reflector surface includes reflector grooves of curved cross section.

7. The fluorescent light fixture of claim 1 wherein said extrusion is of substantially continuous cross section between said ends.

8. The fluorescent light fixture of claim 1 wherein said ballast is fastened to said extrusion rear in said wiring compartment.

9. The fluorescent light fixture of claim 1 wherein said sockets are supported in socket holders contained in said end caps.

10. The fluorescent light fixture of claim 9 wherein said sockets are configured to make a retentive snap fit in said socket holders.

11. The fluorescent light fixture of claim 9 wherein said socket holders are fastened to said extrusion ends.

12. The fluorescent light fixture of claim 9 wherein said socket holders are fastened to said extrusion ends by screws threaded into extruded bosses of said extrusion.

13. The fluorescent light fixture of claim 12 wherein said end caps are retained to said socket holders by a snap fit.

14. The fluorescent light fixture of claim 1 wherein one of said front edges and said lens are configured to make hinging engagement enabling pivotal rotation of the lens between an open and a closed condition.

15. The fluorescent light fixture of claim 14 wherein said one of said front edges defines in transverse cross section a circularly curved slot and said lens has an edge portion of circularly curved cross section adapted to make a sliding fit in said curved slot thereby to achieve said hinging engagement between said lens and said extrusion.

16. The fluorescent light fixture of claim 1 wherein said rear cover makes a snap fit with said rear edges.

17. The fluorescent light fixture of claim 1 wherein said extrusion is of metal, and said rear cover, said lens and said end caps are of plastic.

18. The fluorescent light fixture of claim 1 wherein said extrusion includes an extruded first hinge-half and said lens has a second hinge-half configured to assemble for hinging movement of the lens relative to the extrusion.

19. The fluorescent light fixture of claim 18 wherein said first hinge-half and said second hinge-half assemble to each other by sliding one hinge-half into the other hinge-half.

20. The fluorescent light fixture of claim 1 further comprising electrical end connectors on said end caps.

21. The fluorescent light fixture of claim 20 wherein said electrical end connectors include a male end connector on one of said caps and a female end connector on the other of said caps.

22. The fluorescent light fixture of claim 21 further comprising removable safety caps on said electrical end connectors.

23. The fluorescent light fixture of claim 1 wherein said lens is hinged to a lower one of said front edges such that said lens can be hinged to an open condition dependent from the lower front edge for access to a said lamp tube.

24. The fluorescent light fixture of claim 1 wherein said extrusion has a top and a bottom and said top defines a substantially planar top surface.

25. The fluorescent light fixture of claim 1 wherein said extrusion has a substantially planar top surface between said extrusion front and said extrusion rear.

26. The fluorescent light fixture of claim 24 further comprising means for fastening said top surface to an overlying mounting surface such as the underside of a wall cabinet.

27. The fluorescent light fixture of claim 25 further comprising keyhole openings in said top surface for receiving a fastener head protruding from an overlying mounting surface.

28. A light fixture, comprising:
an extrusion of generally T-shaped cross section including an extrusion top and a generally vertical partition dependent from said top;
a lens supported between one side of said planar top and a bottom of said vertical partition for defining a lamp enclosure; and
a cover supported between an opposite side of said planar top and said bottom of said vertical partition for defining a wiring compartment.

29. The light fixture of claim 28 further comprising end caps at opposite ends of said extrusion for closing opposite ends of said lamp compartment and said wiring compartment.

30. The light fixture of claim 28 further comprising a lamp in said lamp compartment and electrical wiring in said wiring compartment connected for powering said lamp.

31. The light fixture of claim 30 wherein said lamp is a fluorescent lamp and further comprising a ballast connected to said wiring in said wiring compartment.

32. The light fixture of claim 30 further comprising a switch on said cover connected to said wiring for controlling power to said lamp in said lamp compartment.

33. The light fixture of claim 28 wherein said vertical partition defines a light reflector integral with said extrusion.

34. The light fixture of claim 28 wherein said extrusion and said lens are assembled to each other in a sliding fit shaped to enable hinging movement of the lens relative to the extrusion.

35. The light fixture of claim 28 wherein said cover makes a retentive snap fit with said extrusion.

36. The light fixture of claim 28 further comprising screw bosses integral to said extrusion, and lamp socket supports fastened to said extrusion by screws in said screw bosses.

37. The light fixture of claim 28 further comprising fastener portions defined in said top surface for receiving mounting fasteners whereby said extrusion can be mounted to an overlying supporting surface.

38. The light fixture of claim 28 wherein said extrusion top has a generally planar top surface.

39. A lighting fixture comprising an extrusion having a top, a bottom, a front and a rear, a rear cover engageable to said rear for defining with said extrusion a wiring compartment, and a lamp supported in front of said extrusion front and connected to wiring in said wiring compartment.

40. The lighting fixture of claim 39 wherein said extrusion and said rear cover are aluminum extrusions.

41. The lighting fixture of claim 39 further comprising lamp sockets supported at opposite ends of said extrusion for supporting said lamp therebetween.

42. The lighting fixture of claim 39 further comprising a lens hinged to said extrusion for movement between a closed condition for covering said lamp and an open condition for access to said lamp.

43. The lighting fixture of claim 42 wherein said lens is hinged by hinge portions integral to said lens and said extrusion.

44. The lighting fixture of claim 39 further comprising end caps at said opposite ends for covering said sockets and closing said wiring compartment.

45. The lighting fixture of claim 39 further comprising a ballast in said wiring compartment connected for powering said lamp, and electrical connectors on said end caps connected for supplying electrical power to said ballast, said connectors being further connected for receiving electrical power through one of said connectors and supplying electrical power to another lighting fixture through another of said connectors by way of external power cords connected to said connectors.

46. The lighting fixture of claim 39 further comprising end connectors supported on opposite ends of said extrusion and interconnected to each other and to said lamp by wiring in said wiring compartment.

47. The lighting fixture of claim 46 further comprising lamp sockets supported at opposite ends of said extrusion and connected for receiving electrical power from one or both of said end connectors.

48. A lighting fixture comprising an extrusion having a top, a bottom, a front and a rear, a rear cover engageable to said rear for defining with said extrusion a wiring compartment, and a lamp supported in front of said extrusion front and connected to wiring in said wiring compartment;
lamp sockets supported at opposite ends of said extrusion for supporting said lamp therebetween;
end connectors supported on opposite ends of said extrusion and interconnected to each other and to said lamp by wiring in said wiring compartment;
said lamp sockets connected for receiving electrical power from one or both of said end connectors; and
a lens hinged to said front of said extrusion by hinge portions integral to said lens and said extrusion for movement between a closed condition for covering said lamp and an open condition for access to said lamp.

49. The lighting fixture of claim 48 wherein said extrusion and said rear cover are aluminum extrusions.

50. The lighting fixture of claim 48 further comprising end caps at said opposite ends for closing said wiring compartment and covering said lamp sockets.

51. The lighting fixture of claim 48 further comprising a ballast in said wiring compartment connected for powering said lamp.

52. The lighting fixture of claim 48 said end connectors being connected for receiving electrical power through one of said connectors and supplying electrical power to another lighting fixture through another of said connectors by way of external power cords connected to said connectors.

53. A lighting fixture, comprising:
a housing body defining a partition, lamp sockets for supporting a lamp on one side of said partition, a lens hinged to said housing body for covering said lamp, a rear cover engageable to said housing body on another side of said partition, a ballast secured to said other side of said partition and electrically connected to said lamp sockets, and end caps on opposite ends of said housing body for covering said lamp sockets.

54. The lighting fixture of claim 53 wherein said housing body is a metal extrusion.

55. The lighting fixture of claim 53 wherein said lens is hinged by hinge portions integral to said lens and said housing body.

56. The lighting fixture of claim 53 wherein said one side of said partition has an integrally formed reflector for reflecting light emitted by said lamp away from said housing body.

57. The lighting fixture of claim 53 wherein said lens, said rear cover and said end caps are manually engageable to and removable from said housing body without use of tools or separate fasteners.

58. The lighting fixture of claim 53 wherein said housing body has integrally formed screw receiving portions and said lamp sockets are secured by screw fasteners in said screw receiving portions.
